(19) United States
(12) Patent Application Publication
(10) Pub. No.: US 2008/0059630 A1
(43) Pub. Date: Mar. 6, 2008

(54) Assistant

(76) Inventors: Juergen Sattler, Wiesloch (DE); Joachim Gaffga, Wiesloch (DE); Robert Viehmann, Waghausl (DE); Frank Markert, Grossostheim (DE); Robert Holmes, Lauf-Schoenberg (DE)

Correspondence Address: SCHWEGMAN, LUNDBERG & WOESSNER/SAP, P.O. BOX 2938, MINNEAPOLIS, MN, 55402, US

(21) Appl. No.: 11/512,442

(22) Filed: Aug. 29, 2006

(51) Int. Cl. G06F 15/173

(52) U.S. Cl. 709/224; 709/223

(57) ABSTRACT

The present subject mater relates to software application configuration and, more particularly, an improvement assistant for software application configuration. Some of the various embodiment described herein provide systems, methods, and software to maintain a database of key performance indicator metrics and monitor application performance in view of the key performance indictor metrics to identify key performance indicator violations. Some embodiments further provide a key performance indictor violation notice upon identification of a key performance indicator violation.

### TECHNICAL FIELD

The present subject mater relates to software application configuration and, more particularly, an improvement assistant for software application configuration.

### BACKGROUND INFORMATION

Configuring many software applications, such as enterprise resource planning (“ERP”) application, is a large and complex task. Because of the scale of many of these applications, identifying configuration issues and optimizing the configuration can be even more difficult. Many times, even if an issue is identified, administrators are often hesitant to modify the configuration if the application otherwise remains operational. When such applications are not optimized or need to be modified, the total cost of application ownership increases.

### BRIEF DESCRIPTION OF THE DRAWINGS

FIG. 1 is a block diagram of a system according to an example embodiment.

FIG. 2A is a block diagram of a system according to an example embodiment.

FIG. 2B is a block diagram of a system according to an example embodiment.

FIG. 3A is a block diagram of a system according to an example embodiment.

FIG. 3B is a block diagram of a system according to an example embodiment.

FIG. 4 is a block diagram of a change assistant according to an example embodiment.

FIG. 5 illustrates a user interface according to an example embodiment.

FIG. 6 illustrates a user interface according to an example embodiment.

FIG. 7 illustrates a user interface according to an example embodiment.

FIG. 8 is a flow diagram of a method according to an example embodiment.

FIG. 9 is a flow diagram of a method according to an example embodiment.

FIG. 10 is a block diagram of a system according to an example embodiment.

### DETAILED DESCRIPTION

An adaptive organization focuses on improving economics of change to enhance overall performance through profitability, growth, liquidity, and integrity. Many organizations focus on improving information technology processes, applications, and systems to accomplish these goals. This can include automating new processes, collaboration, innovation, resource sharing, and sourcing to optimize resources. These resources can include not only people, products, and services, but also information technology assets and resources. The speed at which automation potential is identified and implemented is important to ensure organization competitiveness.

Thus, continual change has become an integral and vital process in business today. However, the importance of change and dynamics make the task of change more complex and daunting. Organizational processes and the dynamic markets within which the organization competes must be understood.

There are multiple driving factors and market dynamics that lead an organization to employ changes such as internal restructuring and reengineering, environmental and economical factors, market driven changes because of customers, suppliers, and partners, or innovation of new technology and business standards.

The present subject matter provides various systems, methods, and software solutions to address the needs of organizations dealing in such an environment. These solutions overcome many issues that organizations deal with when implementing change. Some such issues include system complexity, know-how, cost and dependency on external consultants, change management, and risk mitigation.

From an information technology perspective, changing the configuration of a software solution can be a major task depending on the changes to be made. Further, identifying the need, and even the possibility, for such a change is difficult. Identifying an application change possibility and need and making such changes requires monitoring and analysis of the software applications of the organization. When an application change possibility or need is identified, the proper individuals need to be notified rapidly.

Various embodiments described herein provides systems, methods, and software provide this monitoring. Some such embodiments monitor performance of one or more software applications in view of one or more performance metrics. In some embodiments, the performance metrics include key performance indicator (“KPI”) metrics. KPI metrics are sometimes referred to as key success indicators (“KSI”).

A KPI metric helps an organization define and measure progress toward organizational goals. These goals and associated KPI metrics can be defined by an organization or are generally accepted KPI metrics in one or more markets or industries. In some embodiments, one or more KPI metrics are provided as part of a software solution.

KPI metrics can be defined in the context of one or more markets within which an organization competes. Other KPI metrics are defined to monitor system performance. Further KPI metrics can be defined to monitor virtually any portion of an organization's business, business operations and processes, or other portion of an organization. Generally, a KPI metric can be defined to monitor anything that is measurable.

In some embodiments, KPI monitoring is performed in view of organizational or system performance. In some embodiments, a KPI is monitored by a process that executes within a software application. When a KPI violation, or impending KPI violation, is identified, the organization is provided with a notice.

When an organization receives a KPI violation notice of an actual or impending KPI metric violation, the organization must decide how to handle that notice. However, responding to such notices is often difficult. In many instances, the response must be thoroughly thought out in view of the organization's business, market, strategy, and other factors.

Some embodiments described herein not only identify actual and impending KPI metric violations, but also propose solutions. In some such embodiments, such solution recommendations include instructions on how to modify an application configuration to improve application performance to overcome or prevent the KPI metric violation. In some such embodiments, the instructions include a guided process to modify the application configuration.

Other embodiments provide solutions that provide abilities to document instances where needs for application change are identified by individuals. Some such embodiments provide messaging and collaboration tools that can be used to request an application change and process that request in a collaborative environment. In some such embodiments, when an application change request is submitted, an administrator receives that request, application change proposals are also provided. Some such embodiments include selecting one or more application change proposals as a function of data included with an application change request. These embodiments, and others, are described herein.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, electrical, or other changes may be made without departing from the scope of the inventive subject matter. Such embodiments of the inventive subject matter may be referred to, individually and/or collectively, in the present application by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described in the present application are implemented in hardware, software or a combination of software and hardware in one or more embodiments. The software comprises computer executable instructions stored on computer readable media such as memory or other type of storage devices. The term “computer readable media” is also used to represent carrier waves on which the software is transmitted. Further, such functions correspond to modules, which may be one or more, or a combination of, software, hardware, or firmware. Multiple functions are performed in one or more modules as desired, and the embodiments described are merely examples. The software may be executed on a digital signal processor, ASIC, microprocessor, or other type of processor operating on a system, such as a personal computer, server, a router, or other device capable of processing data including devices interconnected by a network.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

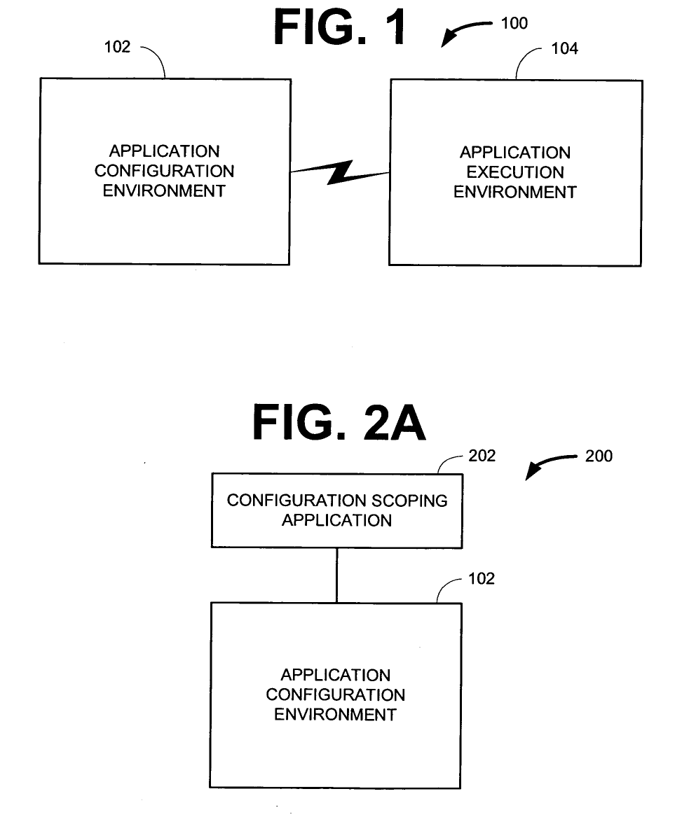

FIG. 1 is a block diagram of a system 100 according to an example embodiment. The system 100 includes an application configuration environment 102 and an application execution environment 104.

The application configuration environment 102 is a system 100 environment within which an application can be configured. However, the application will, or does, execute within the application execution environment 104. In some embodiments, this arrangement of the application configuration environment 102 and the application execution environment 104 separates the configuration of an application from the environment within which it executes. When an application configuration has been established, all or part of the configuration can then be deployed to the application execution environment 104. This deployment can occur to one or more separate instance of the application in the application execution environment 104. Although only a single application execution environment 104 is illustrated, multiple application execution environments 104 can exist, and the deployment can be made to one or more of the multiple application execution environments 104.

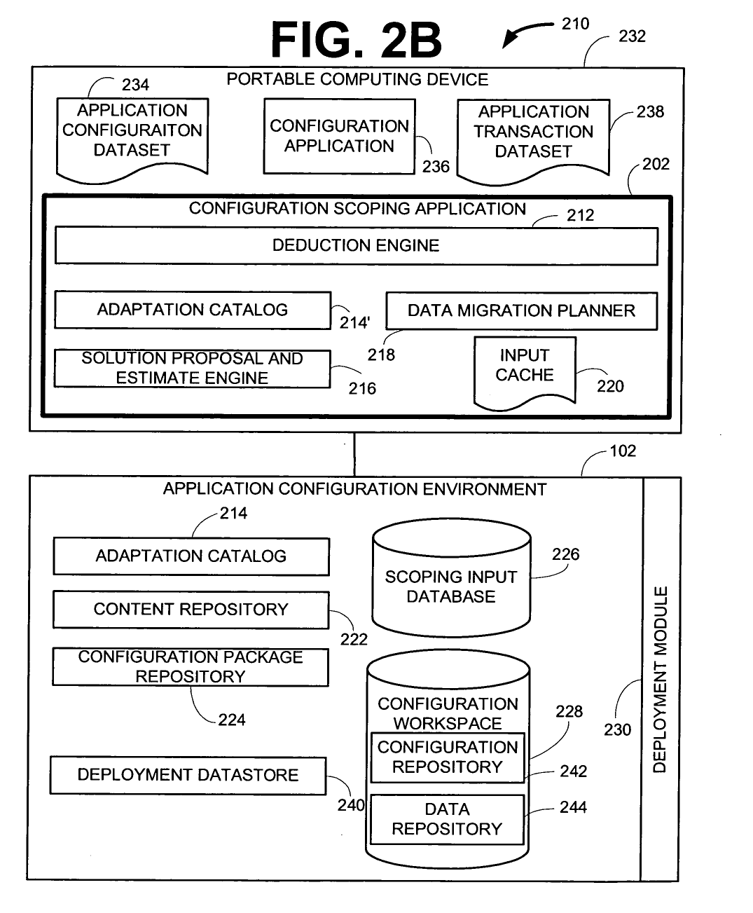

FIG. 2A is a block diagram of a system 200 according to an example embodiment. The system 200 includes a configuration scoping application 202 and the application configuration environment 102.

The configuration scoping application 202 typically is a software tool that executes on a computing device, such as a portable computer, on a same computing device within which the application configuration environment 102 exists, or on another computing device that can be communicatively coupled to the application configuration environment 102.

The configuration scoping application 202, when executed, typically presents a set of scoping questions to a user. The scoping questions are linked to one of many adaptation catalog entries. The adaptation catalog entries include a representation of all of the solution capabilities of an application to be configured, and eventually executed. In some embodiments, the solution capabilities are hierarchically divided into areas, packages, topics, and options. There may be multiple areas and each area may have multiple packages. Each package may have multiple topics and each topic may have multiple options.

In some embodiments, such as in an example embodiment where the application to be configured is an ERP application, the adaptation catalog may provide in the area Sales, a package Customer Order Management that contains the topics Sales Order Quote, Sales Order, Sales Order Analysis, and others. On that level, one or more options typically exist such as Approval Processing.

In the configuration scoping application 202, as stated above, each scoping question may be linked to an adaptation catalog entry. An adaptation catalog entry further includes a rule. These rules typically model dependencies between the areas, packages, topics, and options and corresponding solution capabilities of the application. A rule may specify required inclusion or exclusion of other areas, packages, topics, or options, or may require specification of further areas, packages, topics, or options. A rule may also specify a recommendation or default area, package, topic, or option.

For example, a first example scoping question, “What is the primary focus of your business?” may have three possible answers including “Sales,” “Service,” and “Logistics.” Such a first scoping question typically is aimed at identifying an area of business in which the application is going to be used. Answering “Sales” typically tells the configuration scoping application 202 that the area is “Sales” and a rule tied to the adaptation catalog entry for “Sales” specifies dependencies with packages, topics, and options and the corresponding solution capabilities of the application necessary or optional in using the application in a sales business. Such a rule can also specify that other packages, topics, and options and the corresponding solution capabilities are excluded.

Thus, when a user answers scoping questions, the configuration of the application is being performed. Further, when a question is answered that is associated with an adaptation catalog entry having a rule that excludes another area, package, topic, or option, that rule may be applied to eliminate questions from consideration. Conversely, when a question is answered that is associated with an adaptation catalog entry having a rule that requires another area, package, topic, or option, that same rule may be applied to determine a next question, or group of questions, to ask a user. However, in the event that a question is not answered that is linked to a rule providing defaults, the question may be skipped without adversely affecting the application configuration. FIG. 2B provides further detail of some embodiments of the configuration scoping application 202 in conjunction with an embodiment of the application configuration environment 102.

FIG. 2B is a block diagram of a system 210 according to an example embodiment. The system 210 includes a portable computing device 232 including a configuration application 236, an application configuration dataset 234 stored in a memory, an application transaction dataset 238 and the configuration scoping application 202. The system 210 further includes the application configuration environment 102. Although the application configuration environment 102 is not illustrated within the portable computing device 232, in some embodiments, the application configuration environment 102 may reside within the portable computing device 232. In other embodiments, the application configuration environment 102, the configuration scoping application 202, the application configuration dataset 234, the configuration application 236, and the application transaction dataset 238 may all reside on a computing device other than the portable computing device 232.

The configuration application 236, in some embodiments, typically provides a set of tools via user interfaces to a user. The tools of the configuration application 236 may allow the user to modify answers to scoping question answers stored in an input cache 220 of the configuration scoping application 202, the application configuration dataset 234, and the application transaction dataset 238. The application configuration dataset 234 may be populated with data copied from a configuration repository 242 stored within a configuration workspace 228 of the application configuration environment 102. The application transaction dataset 238 may be populated with data copied either from a demonstration dataset stored in data repository 244 of the configuration workspace 228 or from the content repository 222.

Although the input cache 220 is illustrated within the configuration scoping application 202, the input cache 220 may exist separate from the configuration scoping application 202 within a memory of the portable computing device 232. In such embodiments, the input cache 220 may be populated with data copied from the scoping input database 226.

For the sake of understandability regarding several portions of the configuration scoping application 202 and the application configuration environment 102, these portions of the system 210 will be discussed followed by a more detailed discussion of the configuration application 236.

The configuration scoping application 202, in some embodiments, includes a deduction engine 212 and an adaptation catalog 214′. In this embodiment, the configuration scoping application 202 further typically includes a solution proposal and estimate engine 216, a data migration planner 218, and the input cache 220.

The application configuration environment 102, in some embodiments, includes an adaptation catalog 214, a content repository 222, and a configuration package repository 224. In some such embodiments, the application configuration environment 102 further includes a scoping input database 226, a configuration workspace 118, a deployment module 230, and a deployment datastore 240.

The adaptation catalog 214 may include a representation of all of the solution capabilities of an application to be configured, and eventually executed. Each capability of an application to be configured is identified in an adaptation catalog 214 entry. The adaptation catalog 214 entries each may be identified as an area, package, topic, or option and may be organized in a hierarchy with a child identifying the parent. An example hierarchy is a “General Ledger” capability, which in some embodiments typically is a package having two topics, “cash based” and “accrual based” which are two application capabilities within the “General Ledger” capability.

The adaptation catalog 214 entries may further include scoping questions directed toward obtaining scoping information to determine what areas, packages, topics, and options are relevant to the user's needs. Additionally, the adaptation catalog entries typically include rules, the application of which can require inclusion or exclusion, or specify default inclusion or exclusion, of certain other areas, packages, topics, and options. Thus, because the areas, packages, topics, and options correlate to application capabilities, the inclusion, exclusion, and defaulting specifies what capabilities will be enabled and disabled in the application when deployed by the deployment module 230.

In some embodiments, rules and entries in the adaptation catalog can be linked to a configuration package that exists in the configuration package repository 224. A configuration package includes one or more configuration settings that enable or disable functionality of the application when deployed by the deployment module 230 or by a configuration process within the application configuration environment 102 when configuring the application within the configuration workspace 228. A configuration package can further be linked to one or more content items or content item definitions stored in the content repository 222. Some such content types include report layouts, forms, user interfaces, communication specifications, documentation, key performance indicator metrics, key performance indicator violation solution recommendations, application change recommendations, and other content that can be used in an application when deployed. A communication specification can include an XML schema, an EDI schema and connectivity information, mappings between file layouts and application data storage mechanisms, such as databases, and other similar communication specifications.

A key performance indicator metric may identify one or more data items in the application to monitor after the application is deployed. The key performance indicator metric may further include a rule to apply to the one or more monitored data items. A rule violation correlates, in some embodiments, to an actual or impending key performance indicator metric violation. A key performance indicator metric may further include a reference to one or more key performance indicator metric violation solution recommendations which each provide a recommended solution to correct or prevent the key performance indicator violation.

An application change recommendation typically includes a recommended solution to an application change need. An application change need, in some embodiments, may originate with a user requesting an application change. In other embodiments, a database of application change recommendations can be queried by a user, such as when performing research to determine possible solutions to implement an application change, to increase application knowledge, or to identify alternative application configurations.

The deduction engine 212 of the configuration scoping application 202 may also use the rules of adaptation catalog 214 entries. The configuration scoping application 202 typically presents a user interface to a user that requests answers to questions. The questions to be asked via the user interface may be identified by the deduction engine 212 based on the adaptation catalog 214′. The adaptation catalog 214′ is typically a copy of the adaptation catalog 214 from the application configuration environment 102. When an answer is received by the configuration scoping application 202 through the user interface, the answer may be stored in the input cache 220 of the configuration scoping application 202. The deduction engine 212 may then apply the rule associated with the adaptation catalog 214′ entry of the question asked to the received answer. Through the application of the rule, in view of answers already received and rules already applied, the deduction engine 212 typically identifies a next question to ask. The identified question may then be presented to the user through the user interface. This process typically continues until either all of the questions have been asked, the user is out of time, or otherwise chooses to stop. If questions remain that have not been answered, the process may be continued at a later time or rules specifying default areas, packages, topics, and options typically supply enough information to allow deployment of the application in a functional form.

In some embodiments, the configuration scoping application 218 may further include a data migration planner 218. In such embodiments, one or more additional scoping questions may be asked. These additional scoping questions are typically directed toward obtaining information from the user about legacy systems and how data is stored within them. In some embodiments, the questions simply may ask what systems are currently in use. In other embodiments, the questions may be more detailed to obtain information such as what type of database an application is utilizing and what type of customization has been made or custom applications developed. The data migration planner 218 may then use the answers to these additional questions to propose a data migration plan to the new application.

In some embodiments, the configuration scoping application 202 includes a solution proposal and estimate engine 216. The solution proposal and estimate engine 216 may be used in a sales situation. For example, if a sales person is discussing with a sales lead what a certain application product can do for the sales lead, the sales person typically can utilize the configuration scoping application 202 to obtain information about the needs of the sales lead via the scoping questions. The scoping question answers may then be utilized by the solution proposal and estimate engine 216 to make an initial determination of what will be involved if the sales lead decides to purchase the application. The solution proposal and estimate engine 216 normally is configured to output information for the sales lead to make several determinations, such as the size of effort necessary to implement or transition to the application from legacy system, the cost involved, and cost. In some embodiments, the output of the solution proposal and estimate engine 216 outputs one or more of an implementation cost estimate, an application solution proposal, and a recommended project roadmap. In some embodiments, the solution proposal and estimate engine 216 outputs a proposal for one or more other options, application descriptions, sales literature, benefit statements of using the application, and addition documents, such as a proposal of key performance indicators the application can monitor to assist in managing the application or enterprise of the sales lead.

The solution proposal and estimate engine 216 may output information for the sales lead to make several determinations, such as the size of effort necessary to implement or transition to the application from legacy system and the cost and time involved. In some embodiments, the output of the solution proposal and estimate engine 216 outputs one or more of an implementation cost estimate, an application solution proposal, and a recommended project roadmap. In some embodiments, the solution proposal and estimate engine 216 outputs a proposal for one or more other options, application descriptions, sales literature, benefit statements of using the application, and addition documents, such as a proposal of key performance indicator metrics (“KPIs”) the application can monitor to assist in managing the application or enterprise of the sales lead.

In some embodiments, the proposal of KPIs may include one or more industry standard KPIs selected as a function of an industry identified in the scoping question answers. In other embodiments, the KPIs may include custom KPIs created by the developer of the new application. In yet further embodiments, one or a series of scoping questions receive input from the sales lead that may define one or more custom KPIs.

After the scoping question have been answered, the answers, and any other information obtained from a sales lead or other user of the configuration scoping application 202, the information may be uploaded to the application configuration environment. However, in embodiments, where the configuration scoping application 202 executes on the same computing device as the application configuration environment 202, the scoping question answers and other information may be stored directly to the appropriate areas of the application configuration environment 102.

When the configuration question answers and other information are uploaded, or otherwise stored to the application environment 102, the scoping question answers are may be stored to the scoping input database 226. The scoping question answers, in some instances, are referred to interchangeably as the “scoping information.”

After the scoping information is within the scoping input database 226, a process within the application configuration environment 102 typically executes to begin configuring an application in the configuration repository 242 of the configuration workspace 228. The configuration repository 242 may include a set of configuration tables that mirrors, at least in part, the configuration tables of the application. The configuration repository 242 may include a set of configuration tables for each of multiple instances of the application to allow use of the application configuration environment 102 to configure multiple application instances.

The process that configures the application typically determines one or more configuration packages to instantiate in the configuration repository 242. Configuration packages, in some embodiments, may include one or a set of configuration settings to enable or disable certain capabilities of the application. Configuration packages, as mentioned above, may be linked to adaptation catalog 214 entries and rules associated with adaptation catalog entries. Thus, the process that configures the application in the configuration repository 242 may query the scoping information in the scoping input database 226 to identify configuration packages to instantiate. In some embodiments, one or more KPI metrics may be included in or associated with a configuration package, such as through an adaptation catalog entry rule.

In some embodiments, demonstration data may exist to facilitate instantiation of a demonstration instance of the application for a sales lead, training session, or other purpose. The demonstration data, in some embodiments, is linked to one or more configuration packages from the configuration package repository 224. The demonstration data typically exists in the content repository 222 so that it can be copied into a set of application tables in the data repository 244 of the configuration workspace 228. These tables may hold such data as transactional data, operational data, master data, or other data that can exist in the application when the application is ready for execution or is executed. In some embodiments, the other data includes one or more of KPI metric definitions and application change scenario recommendations. In some embodiments, the application change scenario recommendations include KPI metric violation solution recommendations and application change recommendations.

Once the demonstration data is copied to the data repository 244, that data may be fine-tuned to more closely match the intended use of the demonstration data. For example, the system may be configured so that a sales person, or other individual, can fine-tune demonstration data values to more closely match a sales lead's expectations of the application. Such fine tuning may include modifying sales order documents in the demonstration data to include a name, address, and logo of the sales lead's enterprise, or other similar modifications to the demonstration data.

Some embodiments of the application configuration environment 102 may further include the deployment datastore 240. The deployment datastore 240 typically stores a representation of one or more application configurations of applications that have been deployed. The representations of the one or more application configuration may be stored or updated in the deployment datastore 240 by the deployment module 230 upon successful deployment of an application.

A representation of an application configuration typically includes data representative of the application configuration settings. In some embodiments, the representation may further include data representative of content deployed to the application. In some embodiments, the content to be deployed to the application may include one or more key performance indicator metrics. In some such embodiments, the content to be deployed may further include one or more key performance metric violation solution recommendations associated each associated with one or more of the key performance indicator metrics. In some embodiments, the content to be deployed to the application may also include one or more application change scenarios.

The application change scenarios may include one or more of application change recommendations and KPI metric violation solution recommendations. The application change recommendations may include recommendations to reorganize an organization utilizing the application, upgrade the application, and fine-tune one or more application configuration settings or content uses. The application change recommendations may also include one or more recommendations to add or modify application master data, such as a warehouse layout, how to correct one or more application execution exception or other errors, or other type of application change recommendation.

The deployment datastore 240, in some embodiments, may be updated upon each configuration or content modification of a deployed system. In some embodiments, the deployment datastore may further include a versioning mechanism that maintains not only a current configuration representation, but also historical representations.

In some embodiments, the deployment datastore 240, or a current copy thereof, may be maintained by an entity that developed, or otherwise offers for sale, the application. The deployment datastore 240 may be used by the entity to monitor current application usage, perform billing processes as a function of a current application configuration, provide application upgrade information based on portions of the application or content utilized, to identify new content to distribute to the application, and for other purposes. In some embodiments, the other purposes may include proposing usage of one or more new KPI metrics to monitor organizational or system performance. In some embodiments, the entity may provide application updates, bug fixes, new key performance indicators and associated key performance indicator violation solution proposals, new application change scenarios, or other upgrades directly to a deployed application instance. Such updates, bug fixes, new key performance indicators and associated key performance indicator violation solution proposals, new application change scenarios, or other upgrades may be identified as relevant to a particular application instance as a function of the configuration representation in view of adaptation catalog 214 entries.

As described above, the configuration application 236, in some embodiments, may provide a set of tools via user interfaces to a user. The tools of the configuration application 236 typically allow the user to modify answers to scoping question answers stored in an input cache 220, the application configuration dataset 234, and the application transaction dataset 238. The application configuration dataset 234 may be populated with data copied from the configuration repository 242. The application transaction dataset 238 may be populated with data copied from either a demonstration dataset stored in the data repository 244 or from the content repository 222. The input cache 220, if separate from the configuration scoping application 202 may be populated with scoping information copied from the scoping input database 226.

In some embodiments, the configuration application 236 may further allow a user to define a key performance indicator. In some embodiments, the configuration application 236 is configured to allow a user to define an application change scenario. Such an embodiment can be useful in an instance when a user makes an application change where an application change scenario does not exist. In such embodiments, the knowledge gained by the user making the application change may be added to the organizational knowledge base and leveraged at a later date if the need arises.

The application configuration dataset 234 may be populated with data copied from the configuration repository 242. The application transaction dataset 238 may be populated with data copied either from a demonstration dataset stored in the data repository 244 or from the content repository 222. The input cache 220, if separate from the configuration scoping application 202, may be populated with scoping information copied from the scoping input database 226.

Through use of the configuration application 236 user interfaces, a user can modify data within the application transaction dataset 238. This allows customization of the data used for a demonstration application to more closely reflect how a sales lead's enterprise will use the application. For example, through modifying the transaction data, data displayed within the demonstration may include orders with products, customers, addresses, countries, and other details that truly reflect those of the sales lead's enterprise.

Further, use of the configuration application 236 user interfaces allows a user to further refine an application configuration to more closely match the needs of a customer or sales lead. This can include a user taking a copy of an application configuration to work on while away from a connection to the application to be configured or application configuration environment 102, such as when traveling.

In some embodiments, the configuration application 236 may further include a warehouse-modeling module. The warehouse-modeling module may include a deduction engine 212 and a subset of an adaptation catalog 214 as discussed above, or may leverage the deduction engine 212 and adaptation catalog 214′ of the configuration scoping application 202 if present on the portable computing device 232. In such embodiments, the adaptation catalog 214 (or 214′) may further include one or more area, package, topic, option hierarchies of adaptation catalog 214 entries. The user may answer scoping questions to identify and define a warehouse layout and processes utilized within a warehouse to be modeled. Such warehouse modeling data, once defined, may be copied to the data repository. In some embodiments, such information is similar to configuration settings as a warehouse layout is not subject to frequent change. However, warehouse layouts are generally unique to each warehouse. Thus, warehouse data may be stored in the data repository and may be deployed to an application data table instead of a configuration table.

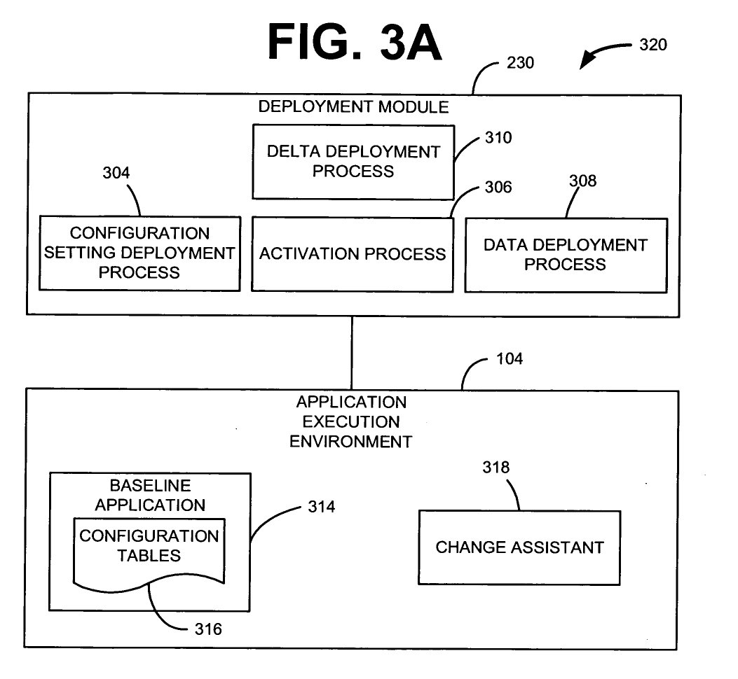

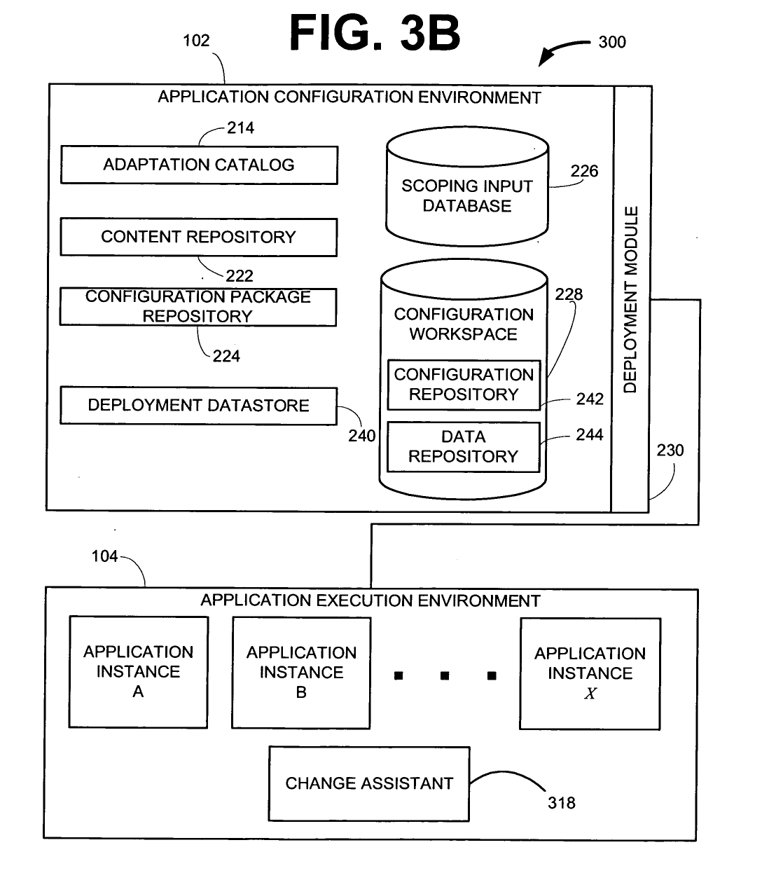

After the application has been configured in the configuration workspace 228 and the demonstration data, if any, is ready, the configuration may be deployed by the deployment module 230. Detail of the deployment module 230 is provided in FIG. 3A. FIG. 3A is a block diagram of a system 320 according to an example embodiment. The system 320 includes the deployment module 320 and the application execution environment 104.

The deployment module 230 typically includes a configuration setting deployment process 304, an activation process 306, and a data deployment process 308. Some embodiments of the deployment module may further include a delta deployment process 310.

The application execution environment 104 typically includes a baseline application 314 and a change assistant 318. Although the change assistant 318 is shown as a separate process within the application execution environment 104, the change assistant 318, in some embodiments, may be a process within the baseline application 314.

The baseline application 314 is an application that has been instantiated, but has not been configured. The baseline application includes a set of configuration tables 316 that may be populated by the deployment module 230. The baseline application 314 further includes other tables, data structures, and storage locations that can be populated by the deployment module 230 with one or more of demonstration data, application data, content, KPI metrics, application change scenario recommendations, or other data.

In some embodiments, the application change scenario recommendations may include KPI metric violation solution recommendations and application change recommendations. The application change recommendations may include recommendations to reorganize an organization utilizing the application, upgrade the application, and fine-tune one or more application configuration settings or content uses. The application change recommendations may also include one or more recommendations to add or modify application master data, such as a warehouse layout, how to correct one or more application execution exception or other errors, or other type of application change recommendation.

The deployment module 230, when executed, typically operates to deploy an application configured in the application configuration environment. Deployment is typically performed by one or more of the processes of the deployment module 310. These processes may include the configuration setting deployment process 304, the data deployment process 208, the activation process 306, and the delta deployment process 310. Some embodiments of the deployment module 230 include one or more of these processes.

The configuration setting deployment process 304 typically deploys configuration settings to the configuration tables 326 of the baseline application 314 if the baseline application 314 has already been instantiated. However, in some embodiments, if the baseline system 314 has not been instantiated, the configuration setting deployment process 304, or other process of the deployment module may instantiate the baseline system 314 or call another process that will instantiate the baseline system 314. The deployment of the configuration settings may include a copying of configuration settings from the configuration tables of the configuration repository 242, as shown and described with reference to FIG. 2B, to the configuration tables 316 of the baseline application. In some embodiments, a configuration setting that is copied to the baseline application 314 may refer to an item of content or data stored in the data repository 244, of FIG. 2B, or the content repository 222, of FIG. 2B. In some such instances, the configuration setting deployment process 304 may call a method of the data deployment process 308 to cause that data or content to be copied to the baseline application 314. In other embodiments, that data or content may be copied when the data deployment process 308 is executed at either an earlier or a later time.

The data deployment process 308 may be executed if there is demonstration data in the configuration workspace 228 or if there is content to deploy from the data repository 244 of FIG. 2B or the content repository 222 of FIG. 2B. If there is demonstration data, the data may be copied from the configuration workspace 228 to application tables, data structures, storage locations, or other data stores in the application execution environment 104. If a proper table, data structure, storage location, or other data store does not exist in the application execution environment, the data deployment process, in some embodiments, is configured to execute, or call a method of another module, to cause that data location to be created or allocated.

Some embodiments of the deployment module 230 may further include the activation process 306. The activation process, in some embodiments, is configured to execute to activate the baseline application 314 after it has been successfully deployed. In some instances, the activation process 314 may require an activation key, message, code, or other authorization from an activation authority to activate the configured baseline application 314. The activation authority may include one or more of a number of individuals or entities. An example of an activation authority may include an entity selling the baseline application 314 to be activated.

This activation process 306 and associated functionality may be utilized for several purposes. Some such purposes may include allowing the entity selling the application to ensure the application is properly configured, has passed certain testing necessary for the entity to ensure it will meet guaranteed service level agreements or objectives, for billing purposes, or other purposes that may benefit from such an activation process.

In some embodiments, the activation key, or other activation signal may be received over a network, such as the Internet. In other embodiments, the activation key, or other activation signal, may be manually input into an administration user interface or configuration table of the configured baseline application 314.

In some embodiments, the deployment module 230 may further include the delta deployment process 310. The delta deployment process is typically only relevant after an application has already been deployed. When an application is deployed, or subsequently modified, a representation of the application configuration may be stored or updated in the deployment datastore 240 as described and illustrated with reference to FIG. 2B. This may enable tracking of a current configuration of a deployed application. In embodiments including the delta deployment process 310, the scoping information may further be tracked on a historical basis to at least allow a view of a current configuration and a modified configuration not yet deployed, if applicable. The delta deployment process 310 may then use that historical tracking of the application configuration to identify changes between the current application configuration and the modified configuration not yet deployed. The delta deployment process 310 may then only deploy the changes to the application configuration and any additional content needed or otherwise referenced by the new application configuration.

In embodiments utilizing KPI metrics to monitor one or more of organizational performance and system performance, after the baseline application 314 is activated, an improvement assistant process within the change assistant 318 begins to execute. The improvement assistant process may execute continuously or periodically. The improvement assistant process typically monitors KPI metrics to identify one or more of an actual or impending KPI metric violation.

The improvement assistant process, in some embodiments, typically delivers to a key user, or group of users within an organization utilizing the application, an evaluation of possible improvements based on the scoping information and the KPI metrics. In some embodiments, the KPI metrics may be defined to measure data such as a number of pending orders, number of possible errors in monthly, quarterly, or year end closing, if business partners exceeds a credit limit, or other measurement to evaluate in view of one or more KPI rules. When a KPI metric rule is violated, or a violation is impending, a solution recommendation may be provided in the context of the implemented areas, packages, topics, and options. These recommendations may be provided in the context within which the application is utilized.

KPI violation solution recommendations may be based on predefined KPIs, audits, and other related activities. The improvement assistant process may recognize problems, discover business or process improvements and upgrade change scenarios, and implement improvements and upgrade content. In some embodiments, the scoping input database 226, as illustrated in FIG. 2B, may be accessible either within the application execution environment 104 or from the application configuration environment 102. Based on the known uses of the system from the scoping information in the scoping input database 226, recommendations may be made in specific cases for improved use of the application and/or to point out potential that further development of the software promises including customer-specific identification of potential via automatic comparison of the used scope.

In some embodiments, the improvement assistant process performs periodic audits of data within the application. One such audit may include an audit of all incomplete sales documents. This audit may identify KPI violations such as failing to close a certain percentage of sales documents within a certain time period. This audit may further identify potential causes for the violation, such as a failure of a business partner to timely ship ordered goods. Thus, when a KPI violation is identified, the improvement process, in some embodiments, may further evaluate the specific scenario to determine a potential cause of the violation. In some instances the potential cause may be an actual cause. In either instance, a KPI violation solution recommendation may be made.

When a KPI solution recommendation is made, the recommendation may be included with one or more other KPI solution recommendations. This allows a key user to evaluate the various recommendations and choose the appropriate recommendation to implement.

A KPI solution recommendation, in some embodiments, typically recommends a process to follow which will correct the KPI violation. In some embodiments, this may include modifying the scoping information in the application execution environment 102. In such instances, application configuration changes caused by the scoping information change will then cascade down as described above and eventually be deployed by the deployment module 230.

In some embodiments, a KPI solution recommendation may recommend obtaining an upgrade to one or more portions of the application. This upgrade may include new content. The new content may provide new functionality or correct previously existing functionality.

In yet further embodiments, a KPI solution recommendation may recommend implementation of a new process that is identified as missing. This process may include a quality control process or other process that may facilitate compliance with one or more KPIs. Such new processes, in some embodiments, include data processing processes that may be added to the application through modification of the scoping information, through implementation of an application upgrade or a new or newly implemented item of application content. In other embodiments, the KPI solution recommendation may include a recommended manual process.

In some embodiments, upon detection of a KPI metric violation, an identifier of the KPI metric violation may be used to query a database of KPI metric violation solution recommendations. This database, in some embodiments, may be further queried based on scoping information. In one such embodiment, the KPI metric violation is a violation of a KPI metric specifying that 97% of all sales documents must be closed within 30 days. The KPI metric, in this embodiment, queries the KPI metric violation solution recommendation database using an identifier of the KPI metric violation and one or more items of scoping information. In this instance, the scoping information used to query the database identifies that the scoping information to used is linked to an adaptation catalog entry specifying whether orders are to be filled with products from stock or will be shipped by a business partner. In this example embodiment, the scoping information specifies that orders are to be filled from stock. Thus, the query to the database identifies the KPI metric violated and that the orders are to be filled from stock.

Continuing with this example embodiment, the KPI violation solution recommendation database may reply to the query with KPI violation solution recommendations matching the query. One example KPI violation solution recommendation may provide a process to follow to increase the amount of product stored in a warehouse to fill orders from. Another example KPI violation solution recommendation may provide a process to follow to change the scoping information which specifies to fill orders from stock to fill orders with shipments from business partners.

In some embodiments, these KPI violation solution recommendations along with notice of the KPI violation may be sent in a message to one or more key users, such as an application administrator, order fulfillment manager, or other interested individual. In some embodiments, the message may be provided within an application dashboard user interface. In other embodiments, the message may be sent via email. In another embodiment, the message may be sent via an SMS text message to a portable device of the key user. The message in some of these embodiments may refer the key user to view a more detailed message in the application dashboard user interface.

FIG. 3B is a block diagram of a system 300 according to an example embodiment. The system 300 includes the application configuration environment 102 as discussed above with regard to FIG. 1, FIG. 2A, FIG. 2B, and FIG. 3A. The system 300 further includes the application execution environment 104.

The application execution environment 104 is a data processing environment within which an application, or an application to be deployed, may execute. When deploying an application, the deployment module 230 typically needs to know what application execution environment 104 and what application instance within that environment to deploy to. In embodiments including only one application execution environment 104, the application execution environment 104 may already be known. Similarly, in an application execution environment including only a single application instance, the instance may already be known.

Each instance of the application (i.e., application instances A, B, . . . X) typically includes a set of identical configuration tables which may include distinct configuration settings from one another. In some embodiments, multiple instances of the application may exist such as to provide a development instance, a test instance, and a production instance. In such embodiments where there are multiple application instances, the deployment module 230 may deploy the configuration settings from one of the application instances in the application execution environment 104 to another application in the same or another application execution environment 104. Although the deployment module 230 is illustrated as being a part of the application configuration environment 102, the deployment module 230, in other embodiments, may be a standalone application or a part of another application or process.

The application execution environment 104, in some embodiments includes the change assistant 318. The change assistant 318 is shown as a process separate from the application instances. In such embodiments, the change assistant 318 is a shared process between the application instances. In other embodiments, a change assistant 318 may exist for each application instance. In some such embodiments, the change assistant 318 may be a process within each application instance.

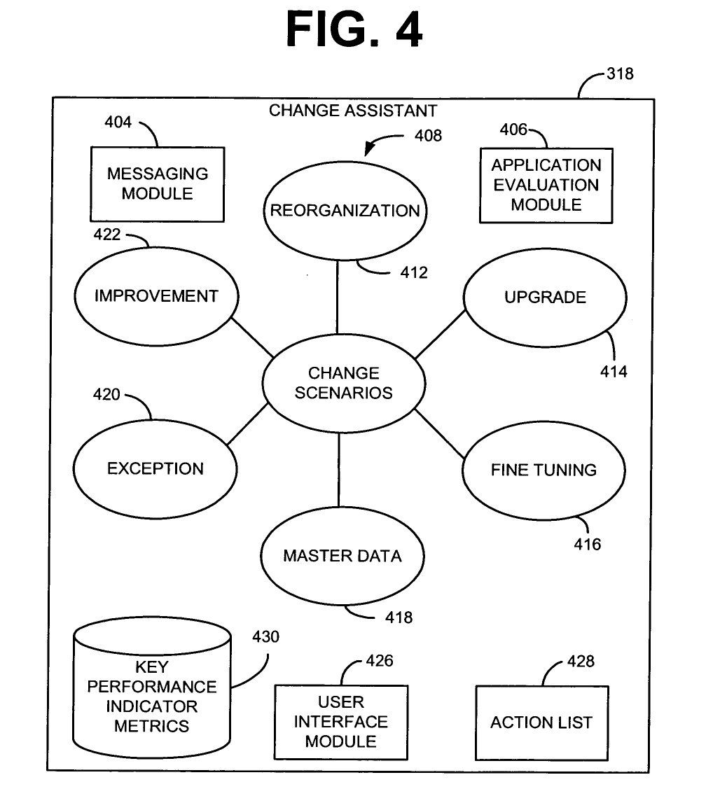

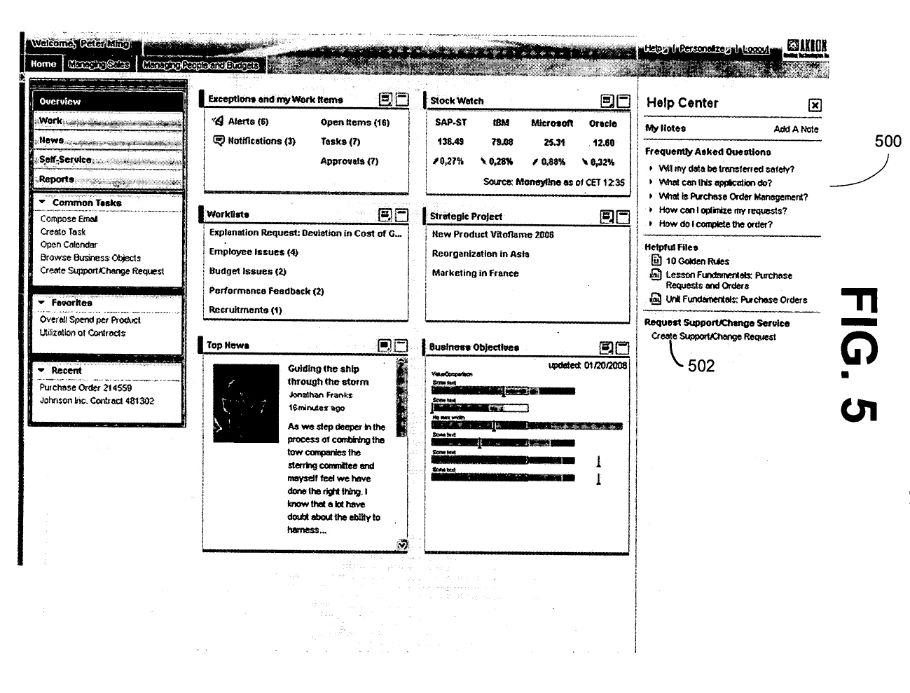

FIG. 4 is a block diagram of a change assistant 318 according to an example embodiment. The change assistant 318, includes one or more of a database of change scenarios 408, a messaging module 404, an application evaluation module 406, a user interface module 426, and an action list module 428.

The database of change scenarios 408 may include change scenarios of various types. The types of change scenarios may include one or more of reorganization 412, upgrade 414, fine tuning 416, master data 418, exception 420, improvement 422, and other change scenario types depending on the specific embodiment. A change scenario, in some embodiments, typically provides a recommended procedure to follow to implement a change in an application. Such procedures may include recommended changes to scoping information, configuration setting change, application and content upgrades, addition of processes to the application or manual processes, upgrading the application, and other procedures. The procedures, in some embodiments, commonly provide information that may be necessary to make a change to correct a KPI metric violation or implement an identified need for an application change.

Some change scenario processes may refer to other change scenarios to implement an application change. Referencing between change scenarios may occur where a change scenario to upgrade a portion of the application requires fine-tuning of one or more configuration settings to implement the upgrade.

In some embodiments, a change scenario may further include a change scenario impact discussion of other portions of the application that may be affected by following the change scenario.

A reorganization 412 change scenario typically provides a process to implement a reorganization of an organization or process. An upgrade 414 change scenario typically provides a process to obtain and implement an upgrade to application functionality or content. A fine tuning 416 change scenario typically provides a process to fine tune one or more portions of the application. A master data 418 change scenario typically provides a process to modify one or more items of master data. An exception change scenario 420 typically provides a process to correct application execution exceptions such as data fixes or application configuration changes. An improvement change scenario 422 typically provides a process to improve application performance. In some embodiments, the improvement change scenarios 422 may provide KPI violation solution recommendations.

In some embodiments, the application change scenarios may be stored in the application change scenario database 408 with metadata descriptive of one or more of the application change scenarios. In some embodiments, this metadata facilitates a linking of application change scenarios to one or more KPI metrics. In other embodiments, the metadata facilitates querying of the application change scenarios. In some embodiments, a query of the metadata is may be performed automatically to identify application change scenarios relevant to a received application change request or upon identification of a KPI metric violation. In some embodiments, the queries are key-word queries.

The key performance indicator metrics database 430 typically include definitions of one or more KPI metrics. The KPI metrics of the key performance indicator metrics database may be utilized by the application evaluation module 406 to monitor performance of one or more the application and organization performance.

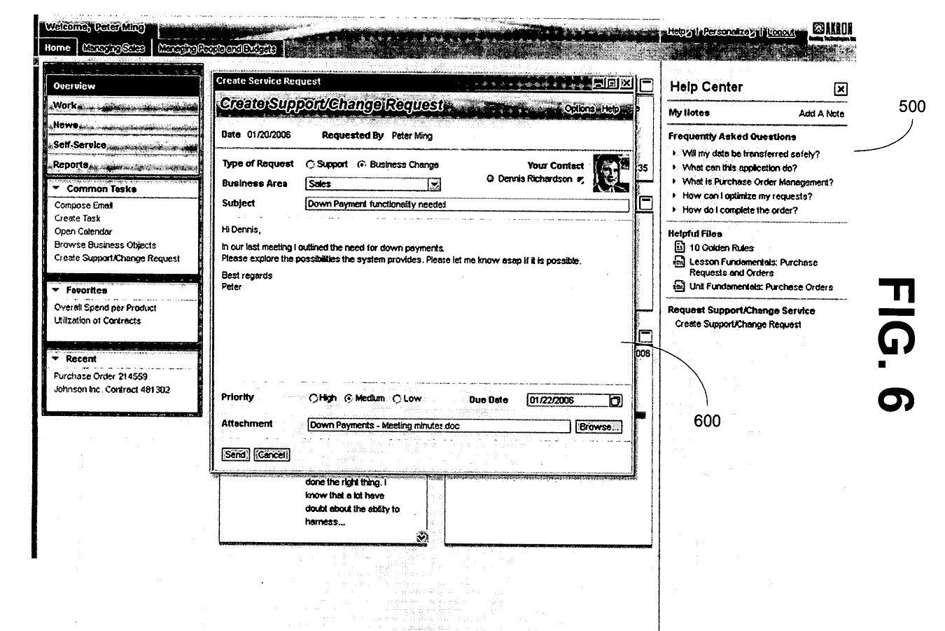

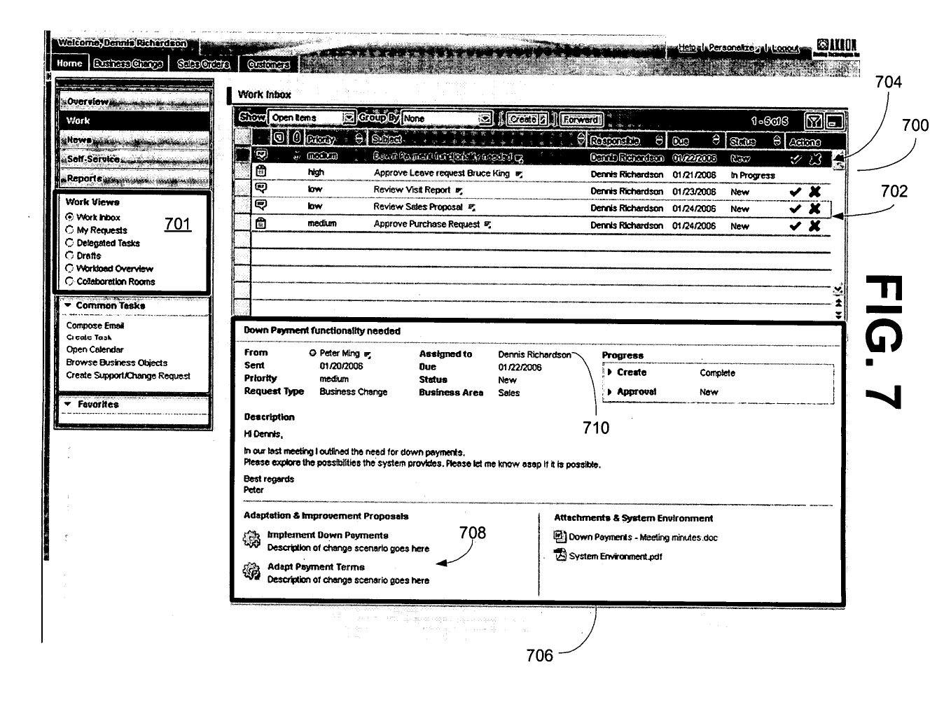

The user interface module 418 typically provides one or more tools in one or more user interfaces. In some embodiments, the user interfaces may allow users to generate identified application change need messages, view KPI metric violation and identified application change need messages, view change scenarios, and delegate KPI metric violation and identified application change need messages to an appropriate individual. Some user interfaces may further allow a user to implement change scenarios, view an action list from the action list module 428, and mark actions within an action list completed. Some such user interfaces are discussed below with reference to FIG. 5, FIG. 6, and FIG. 7.

In some embodiments, the action list module 428 is typically populated with process steps from change scenarios. These process steps may be delegated to individuals to perform. Process steps delegated to an individual may be viewed by the individual in an action list user interface, or other user interface. When the user has completed the delegated process step, the user may mark the process step completed. The action list module 428 allows for status tracking of process steps.

FIG. 5 illustrates a user interface 500 according to an example embodiment. The user interface 500 is a dashboard user interface that provides information to a user including information regarding the application. The user interface further provides a link 502 to request application change or other application support. This link is selectable by a user to cause a support/change request user interface to be displayed.

FIG. 6 illustrates a user interface 600 according to an example embodiment. The user interface 600 allows a user to submit a request for application support including changes to the application. The user interface 600 allows a user to specify whether the request is for an application or business change or for support. The user interface 600 further allows the user to include additional information regarding the request in a text box. Some embodiments further allow a user to specify a priority of the request, attach files, and specify a date by which fulfillment of the request is needed. In some embodiments, the user interface 600 makes note of where the user is at within the application and includes that information with the request. This is useful in fulfilling some such requests where an administrator considering the request may need to know what portion of the application the request is relevant to or to give the administrator an application context of the request.

FIG. 7 illustrates a user interface 700 according to an example embodiment. The user interface 700 is an interface provided to a user with message information 702. Some such messages, such as message 704, are application support/change requests. Other messages are KPI metric violation messages. Both of these message types include more detailed information 706 providing detail of the request or the KPI metric violation. These messages further include information such as change scenarios 708 identified to either implement the requested change or resolve the KPI metric violation. Some such user interface further provide the ability to assign a message to one or more other users. When a message is assigned to a user, the name of that user 710 is identified in the message detail 706. If a document is attached to the viewed message, a linked identifier of the attachments is provided within the message detail 706.

The change scenario 708 information within a message includes a link to one or more change scenarios. These change scenarios, when selected, provide change scenario details in another user interface.

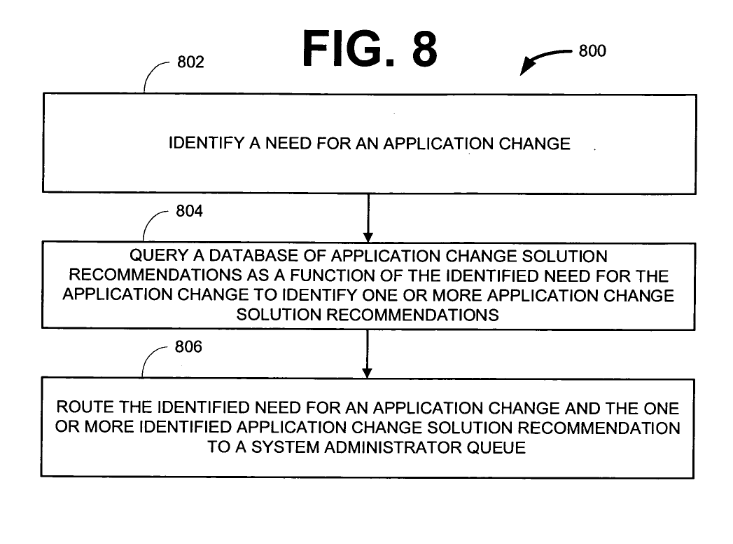

FIG. 8 is flow diagram of a method 800 according to an example embodiment. The example method 800 includes identifying a need for an application change 802 and querying a database of application change solution recommendations as a function of the identified need for the application change to identify one or more application change solution recommendations 804. The method 800 further includes routing the identified need for an application change and the one or more identified application change solution recommendation to a system administrator queue 806.

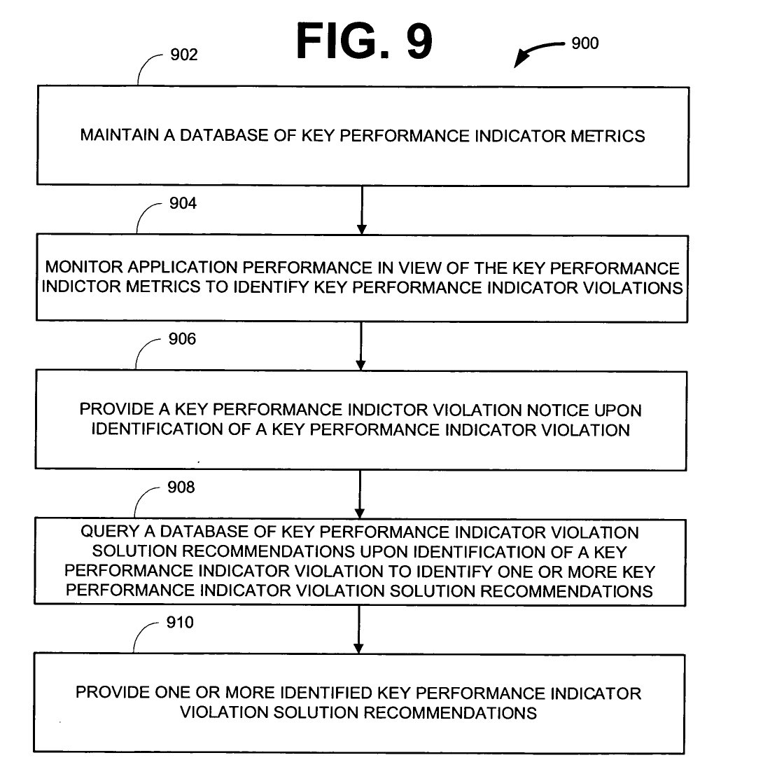

FIG. 9 is flow diagram of a method 900 according to an example embodiment. The example method 900 includes maintaining a database of key performance indicator metrics 902 and monitoring application performance in view of the key performance indictor metrics to identify key performance indicator violations 904. The method 900 further includes providing a key performance indictor violation notice upon identification of a key performance indicator violation 906. A key performance indicator metric can include a threshold value that is used in the monitoring 904 to identify an impending key performance indicator violation.

Some embodiments of the method 900 also include querying a database of key performance indicator violation solution recommendations upon identification of a key performance indicator violation to identify one or more key performance indicator violation solution recommendations 908. Such embodiment further include providing one or more identified key performance indicator violation solution recommendations 910. The one or more identified key performance indicator violation solution recommendations can be provided with the key performance indictor violation notice.

In some embodiments, a key performance indicator violation solution recommendation includes a guided procedure to aid identification of a root cause of the key performance indicator violation. In these, and other embodiments, a key performance indicator violation solution recommendation can also include a guided procedure to correct the key performance indicator violation.

In some embodiments, the method 900 also includes routing the key performance indicator violation notice and one or more identified key performance indicator violation solution recommendations to a system administrator queue.

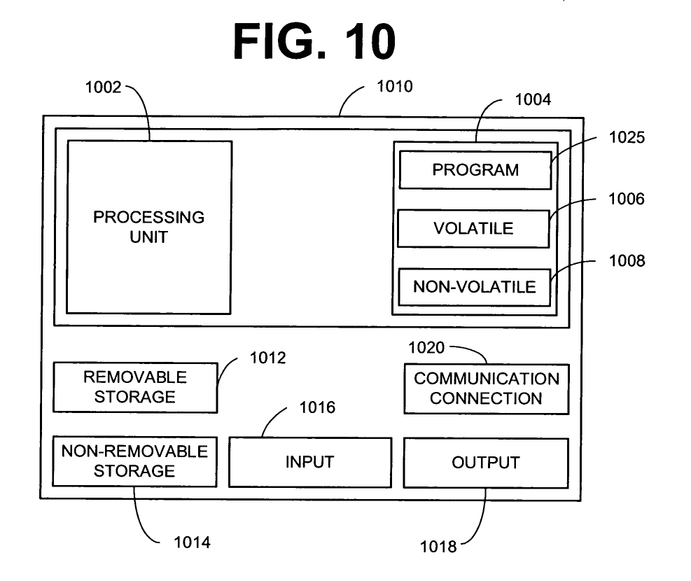

FIG. 10 is a block diagram of a computing device according to an example embodiment. In one embodiment, multiple such computer systems are utilized in a distributed network to implement multiple components in a transaction based environment. An object oriented architecture may be used to implement such functions and communicate between the multiple systems and components. One example computing device in the form of a computer 1010, may include a processing unit 1002, memory 1004, removable storage 1012, and non-removable storage 1014. Memory 1004 may include volatile memory 1006 and non-volatile memory 1008. Computer 1010 may include—or have access to a computing environment that includes—a variety of computer-readable media, such as volatile memory 1006 and non-volatile memory 1008, removable storage 1012 and non-removable storage 1014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 1010 may include or have access to a computing environment that includes input 1016, output 1018, and a communication connection 1020. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks. Computer-readable instructions stored on a computer-readable medium are executable by the processing unit 1002 of the computer 1010. A hard drive, CD-ROM, and RAM are some examples of articles including a computer-readable medium. The term “computer readable medium” is also used to represent carrier waves on which the software is transmitted. For example, a computer program 1025 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 1010 to provide generic access controls in a COM based computer network system having multiple users and servers.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A method comprising:
maintaining a database of key performance indicator metrics;
monitoring application performance in view of the key performance indictor metrics to identify key performance indicator violations; and
providing a key performance indictor violation notice upon identification of a key performance indicator violation.

2. The method of claim 1, further comprising:
querying a database of key performance indicator violation solution recommendations upon identification of a key performance indicator violation to identify one or more key performance indicator violation solution recommendations; and
providing one or more identified key performance indicator violation solution recommendations.

3. The method of claim 2, wherein the one or more identified key performance indicator violation solution recommendations are provided with the key performance indictor violation notice.

4. The method of claim 2, wherein a key performance indicator violation solution recommendation includes a guided procedure to aid identification of a root cause of the key performance indicator violation.

5. The method of claim 2, wherein a key performance indicator violation solution recommendation includes a guided procedure to correct the key performance indicator violation.

6. The method of claim 2, further comprising:
routing the key performance indicator violation notice and one or more identified key performance indicator violation solution recommendations to a system administrator queue.

7. The method of claim 1, wherein a key performance indicator metric includes a threshold value that is used in the monitoring to identify an impending key performance indicator violation.

8. A machine-readable medium, with encoded instructions, which when executed, cause a machine to:
maintain a database of key performance indicator metrics;
monitor application performance in view of the key performance indictor metrics to identify key performance indicator violations; and
provide a key performance indictor violation notice upon identification of a key performance indicator violation.

9. The machine-readable medium of claim 8, wherein the instructions, when further executed, cause the machine to:
query a database of key performance indicator violation solution recommendations upon identification of a key performance indicator violation to identify one or more key performance indicator violation solution recommendations; and
provide one or more identified key performance indicator violation solution recommendations.

10. The machine-readable medium of claim 9, wherein the one or more identified key performance indicator violation solution recommendations are provided with the key performance indictor violation notice.

11. The machine-readable medium of claim 9, wherein a key performance indicator violation solution recommendation includes a guided procedure to aid identification of a root cause of the key performance indicator violation.

12. The machine-readable medium of claim 9, wherein a key performance indicator violation solution recommendation includes a guided procedure to correct the key performance indicator violation.

13. The machine-readable medium of claim 9, wherein the instructions, when further executed, cause the machine to:
route the key performance indicator violation notice and one or more identified key performance indicator violation solution recommendations to a system administrator queue.

14. The machine-readable medium of claim 8, wherein a key performance indicator metric includes a threshold value that is used in the monitoring to identify an impending key performance indicator violation.

15. A system comprising:
a database of key performance indicator metrics; and
an application performance monitoring module to monitor performance of an application in view of the key performance indictor metrics to identify key performance indicator violations, wherein upon identification of a key performance indicator violation, a notice is given.

16. The system of claim 15, further comprising:
a database of key performance indicator violation solution recommendations that can be queried to identify one or more application change solution recommendations as a function of an identified key performance indicator violation.

17. The system of claim 16, wherein the one or more identified key performance indicator violation solution recommendations are provided with the key performance indictor violation notice.

18. The system of claim 16, wherein a key performance indicator violation solution recommendation includes guided procedure instructions to aid identification of a root cause of the key performance indicator violation.

19. The system of claim 16, wherein a key performance indicator violation solution recommendation includes a guided procedure to correct the key performance indicator violation.

20. The system of claim 15, wherein a key performance indicator metric includes a threshold value that is used by the application performance monitoring module to identify an impending key performance indicator violation.
